(19) United States
(12) Patent Application Publication
(10) Pub. No.: US 2025/0124348 A1
(43) Pub. Date: Apr. 17, 2025

(54) APPARATUS, METHOD, AND SYSTEMS FOR PORTABLE MACHINE LEARNING OPERATIONS

(71) Applicant: Qualcomm Technologies Inc., San Diego, CA (US)

(72) Inventor: Erich Plondke, Greenwood, IN (US)

(73) Assignee: Frugal Computing Corporation, Greenwood, IN (US)

(21) Appl. No.: 18/822,649

(22) Filed: Sep. 3, 2024

Related U.S. Application Data
(60) Provisional application No. 63/543,549, filed on Oct. 11, 2023.

(51) Int. Cl. G06N 20/00

(52) U.S. Cl. CPC G06N 20/00

(57) ABSTRACT

The present invention relates to the field of machine learning operations. More particularly, it is directed to apparatus, method, and systems for portable machine learning operations adapted to operate on dissimilar computing systems and provide substantially similar results. A method for exact computation of an optimized set of Lookup Table operations within machine learning is provided. The exact outputs can be used to then further create operations that produce exactly correct results based on the implementation.

### CROSS-REFERENCE TO RELATED APPLICATIONS

This application claims the benefit of Provisional Application Ser. No. 63/543,549, filed 11 Oct. 2023 (“Parent Provisional”).

This application claims priority to:

1. the Parent Provisional;

collectively, “Priority References”, and hereby claims benefit of the filing dates thereof pursuant to 37 C.F.R. § 1.78 (a).

The subject matter of the Priority References, each in its entirety, are expressly incorporated herein by reference.

### FIELD OF INVENTION

The present invention relates to the field of machine learning operations. More particularly, it is directed to apparatus, method, and systems for portable machine learning operations adapted to operate on dissimilar computing systems and provide substantially similar results.

### BACKGROUND

### Integer Arithmetic

Integers contain the whole numbers (0, 1, 2, 3) as well as the negative whole numbers. Computation on integers, such as multiplication and addition, is well known in the art. Additionally, various techniques for simplifying integer multiplication and addition (such as booth encoding and compression) are known in the art. Many of these techniques rely on mathematical properties of integer addition and multiplication, such as the associative property (where the order that additions and subtractions happen in will not affect the result).

Integer multiplication, addition, and subtraction yield exact results as long as overflow is avoided. Overflow is the condition where the fixed range of a number space is not sufficient to distinguish a very large number from smaller ones. By way of example, and without limitation, in decimal if you have a 5 digit number, and you add 1 to 99999, the full precision resulting value cannot be represented in five digits. Two main techniques exist for handling overflow. Either the result can be saturated to the largest-magnitude possible value, or the result can wrap around. In the case of saturation, the result is inexact and saturation of intermediate values may cause the order of operations to yield different results. For the case of wrapping the value around, the result will be exactly correct regardless of the order of computation if the final result is in the valid number range. However, when wrapping around it is difficult to be able to determine whether the final result is actually in the valid number range, and the error can be extremely large compared with saturation. Using our five-digit example, if you add 1 to 99999 and choose to saturate, your result is still 99999. If you wrap around, your result is 00000. If you then subtract 1 from that result, with saturating arithmetic you would get 99998 (which is incorrect) but with wraparound you would get 99999 (the correct answer). Also observe that if the (1-1) is computed first then the addition of 0 will yield the correct 99999 answer regardless of the overflow-handling scheme used.

### Floating Point Arithmetic

Floating Point Arithmetic uses a concept like scientific notation to encode numbers. This allows very large or very small numbers to be encoded, but with a fixed precision relative to nearby numbers.

Floating point numbers are always rational, and the denominator of the rational number is a power of two based on the exponent. As you would expect from multiplying two rational numbers, the result is also a rational number, and the denominator is some multiple of the product of the two multiplicand denominators. By way of example, and without limitation, if the two inputs to a multiply are both multiples of ½, the resulting product must be a multiple of ¼.

Addition in floating point is more complex. The two inputs to addition (or subtraction) must have their values aligned before an addition can occur. This involves shifting the input values to ensure that they have the same alignment. If effective subtraction (subtraction of two like-signed values or addition of two opposite signed values) of similar-sized numbers occurs, the result may need to be shifted to the normalized position.

Since floating point numbers have a fixed amount of precision, the result may need to be rounded at the end of a computation. Rounding may involve an addition, and this can make the entire value need to be re-aligned if the addition rounds up. The analogous situation in decimal scientific notation is if you are rounding up 9.999×10\hat{ }3, you get 10.000×10\hat{ }3, but this needs to be renormalized to 1.000×10\hat{ }4.

Rounding numbers gives a new value that is an approximation of the full-precision result. This introduces error to the result. Additionally, this error means that computations using floating point values are not associative. By way of example, and without limitation, if we are adding values in decimal scientific notation with three significant figures, if you add 1.00×10\hat{ }6+1.00×10\hat{ }0-1.00×10\hat{ }6, you will get a different result if you add them in order or if you add them from largest magnitude to smallest. In the first case, 1.00×10\hat{ }6+1.00×10\hat{ }0 is still 1.00×10\hat{ }6 after rounding, because the value added is too small for the precision available. Subtracting 1.00×10\hat{ }6 yields a result of zero. However if you first subtract 1.00×10\hat{ }6 from 1.00×10\hat{ }6, you get zero, and adding 1.00×10\hat{ }0 will leave you with 1.00×10\hat{ }0.

Exact computations in floating point are associative. It is only when floating point results are inexact that the computation becomes order-dependent. The IEEE standard for floating point computation has a flag that is raised whenever an inexact computation occurs. Although this flag is nearly always ignored because of the way floating point is used in most programs, it is a way that developers can get an indication that rounding has occurred and so the computation may not be associative.

In Machine Learning workloads, a large part of the computation is done via the “dot product”, which is the sum of the elementwise multiply of two input vectors. For efficient implementations of these dot products, it is often desirable to use the associative property of addition to add the intermediate products up in various orders. However, if rounding has occurred for any intermediate result, the result will not be exact and the order of computation may change the resulting value.

Floating point arithmetic is often convenient for programmers, as for most cases where numbers are utilized, they can be used without concern for the precision. Single-precision floating point arithmetic, By way of example, and without limitation, is approximately equal to decimal scientific notation with approximately 7 digits of significand and two digits of exponent. This is enough to easily handle the mass of an electron in kg, or the distance between galaxies in meters, with sufficient precision for most calculations that need to be performed. This makes computation using floating point values desirable for programmers because in most cases the limitations in accuracy or associativity can be ignored.

However, in machine learning workloads, the lack of an exact result makes it more difficult for hardware and software infrastructure to be built, since different techniques for computation may yield different, yet valid, results. Similarly, in situations where safety is critical, the lack of a known, correct answer that is guaranteed to not change may be of concern.

Additionally, floating point computation is often more expensive than integer computation, taking more energy and more silicon area to perform equivalent tasks. Machine learning operations that could be computed using either floating point or integer hardware would allow more efficient implementations.

### Bit Exact Dot Products

A dot product is the sum of the elementwise product of two vectors. Dot product computation is the building block of matrix multiplication and many related machine learning operations.

For bit exact dot products, the inputs to the dot products are numbers which have been constrained to a suitable number space. This number space should be representable exactly in both floating point and integer (or fixed point) values. By way of example, and without limitation, the integers −128 to +127 are exactly representable as integers (using a common 8-bit two's complement value) or as floating-point values (in single precision, half precision, or other common formats). Other number spaces are also possible, however. By way of example, and without limitation, we could encode the range 0 to 255 with the same number of integer bits. As another example, if we want to continue to use an 8 bit two's complement number but want to encode values approximately between −1 and +1, we may choose rational numbers with a common denominator of 128. We can then encode the range [−1 . . . 127/128] in 8 bit integers, as well as encode these values in floating point easily. The shared exponent for all fixed point values is a well known technique called “block floating point”. For simplicity, we will use the integer range in our examples.

For both integer and floating point calculation, the products of two of these values can be captured exactly with sufficient precision. Furthermore, sums of those products can be captured exactly with sufficient precision. For the example 8 bit signed values above, single precision floating point contains sufficient precision for all of the intermediate products, as well as the sum of all intermediate products up to the exact sum of 1024 products. A 32-bit integer value can hold the exact sum of over 130,000 products.

In machine learning workloads it is common for the dot product length to exceed 1024. In these cases, the dot product of a certain length that is known to be exact can be performed, and then the sums of those values can be computed with extra precision. Even if the extra precision is slower, the frequency of the slower operations is reduced so the overall overhead is low.

As an alternative strategy, value range analysis can be used to determine maximum dot product length. If some values are constant and known to be small, then that knowledge can be used to provably determine that a larger dot product length can be used without the possibility of overflow. As an example in the extreme, if half the values of one input are known to be zero, we can double the possible dot product length without the possibility of overflow. More exactly, if one input is constant, the sum of negative values and the sum of positive values can be computed, and if both of those values times the maximum possible value of the other input will not overflow, then no overflow can occur. In machine learning dot products, it is common for one input to be constant and therefore this analysis can often be done.

Some techniques for extra precision known in the art are increased precision floating point computation, such as double precision, the “2Sum” floating point computation, or detection and conditional addition/subtraction to simulate a “carry” to an upper sum.

This high precision floating point value can be adjusted. Many Machine Learning operations have a “bias” value that is added to the dot product. Additionally, rounding or offset constants can be added to the extended precision value.

Some other operations can be performed in a bit exact fashion. By way of example, and without limitation: multiplying by a power of two is an exact operation for floating point values, as it only affects the exponent, unless the result is near underflow or overflow. This can also be done in a similar fashion for block floating point by adjusting the shared exponent. Multiplying the final results by some more arbitrary values may be beneficial, however continuing to have a fully exact value may require more bits quickly. Certain operations may be done conditionally, such as different operations done for positive and negative values.

For the final result, the extended precision value needs to be reduced to the number space required by the next operation. This will require producing an inexact result, but since this inexact result is the final value it will not break order independence, and it will be exact between implementations if it is well-defined. One example of a well-specified result might be clamping to a minimum and maximum value, a division by a power of two, and rounding or truncating off any fractional value in a specified way. Dividing positive values by a power of two might be accomplished on integers with a logical shift right. Truncating bits on floating point values by utilizing the floor ( ) function or more directly with operations utilizing the round-down rounding mode (or round-towards-zero mode for positive values).

As an example of rounding to a fixed set of bits in floating point, adding 2\hat{ }23 to a single precision floating point value less than 2\hat{ }23 will align the integer one's place as the least significant bit. Using the round-towards-zero rounding mode will cause all the fractional bits to be truncated off. Subtracting the 2\hat{ }23 value will return the original value (with the fractional values truncated off).

### Bit Exact Normalization

In machine learning, current methodologies utilize a technique called normalization to keep values in a convenient range. Typically, this range is desired to have a certain mean and standard deviation. Normalization creates this desired mean and standard deviation by computing the mean and standard deviation of a set of values, subtracting the calculated mean from each value, dividing that by the standard deviation, and then multiplying by whatever desired standard deviation is desired (a “gamma” term) and adding whatever mean is desired (a “beta” term). If the “gamma” value is 1.0 and the “beta” value is 0.0, the result would have a zero mean and a standard deviation of 1.0.

This normalization technique may be used on different amounts of data. Normalizing on all of the data is a technique at the most extreme (“batch normalization”) and at the other extreme small amounts of data may be independently normalized (“instance normalization”).

Calculation of the mean and standard deviation requires careful consideration to assure numerical stability. Important aspects include avoiding overflow as values can become quite large, as well as avoiding loss of precision because of “massive cancellation” when subtracting two values of similar magnitudes. Other numerical problems can occur during accumulation when small values become lost as the overall sum is large.

Floating point multiplication and addition is inexact unless special care is taken. Rounding of any inexact result during floating point addition makes the sum inexact, but also makes the calculation not associative. As different implementations may calculate the sum in a different order, the overall result may change.

While addition and multiplication have techniques for finding exact results, division and square root operations are typically utilized when normalizing the values. The results of division and square root are often not able to be exactly represented in any typical computer number system. By way of example, and without limitation, numbers like ⅓ or the square root of 2 cannot be exactly represented by a fixed point or floating point number.

Variance is the mean of squares of each value minus the mean of values squared. The mean is often computed first. Since variance is shift invariant, once the mean is determined, every value can have the mean subtracted. This will cause the new “mean squared” term to be zero, and we have a single “mean of squares” term of each input minus the mean. This is beneficial for numerical stability, but other formulations for exact results may be better. To find an exact result, we will reformulate the overall computation.

### BRIEF SUMMARY OF THE INVENTION

According to one embodiment, a method is described for exact computation of an optimized set of Lookup Table operations in machine learning, such that the optimized operations may be used to further improve efficiency. In machine learning workloads, there are a lot of unary functions that shape the values in some way. Some examples:

$$“ Relu ” : x = max ( 0 , x )$$

$$“ Log ” : x = log ( x )$$

$$“ Tanh ” : x = tanh ( x )$$

$$“ Sigmoid ” : x = 0.5 + 0.5 * tanh ( 0.5 * x ) ( or something like that )$$

$$“ PRelu ” : if ( x < 0 ) : x = a * x$$

$$“ Gelu ” : 0.5 * x * ( 1 + erf ( x / sqrt ( 2 ) ) )$$

$$“ Swish ” : x * sigmoid ( x )$$

Other example and embodiments are anticipated. Most activation functions are unary functions. We define that all of them be replaced with lookup tables, defining the exact output for each possible input value. This ensures that all activation functions (indeed, all unary functions) can be supported with all combinations of input and output quantization in a portable way: the exact outputs for any given input are defined as the constant input for the lookup table in the graph.

At high precisions these tables could get large. Lookup tables, especially large ones, may be inefficient to use as a mechanism for computation. Implementations are free to go back the other way and find some simplified computation that gets the exact answer for all inputs. Depending on the features of the implementation software/hardware architecture that might yield lots of different options for implementation. As long as it gets the right output for any input, the replacement is valid. Note that as activation functions get fused in, rounding may make the exact results cumbersome, but the exact lookup table results must be respected for exact answers.

Replacing well-known unary operations with lookup tables that are approximate and known to have efficient implementations can help performance later on. Those skilled in the art will understand that these procedures can be used to convert many operations in a machine learning graph into an optimized set of Lookup Table (LUT) operations that specify exactly the desired output values. Furthermore, these exact output values can then be used as an exact specification for any implementation to create operations that produce exactly correct results utilizing whatever features are available in the implementation. This combination of exact portability and high efficiency is very desirable.

### BRIEF DESCRIPTION OF THE SEVERAL VIEWS OF THE DRAWINGS

FIG. 1A illustrates, in flow chart form, a process to reduce the precision of a value.

FIG. 1B illustrates, in flow chart form, a process to reduce the precision of a value used for integer-style computation.

FIG. 2A illustrates, in flow chart form, a lookup table process.

FIG. 2B illustrates, in flow chart form, a lookup table optimization process.

FIG. 2C illustrates, in flow chart form, another lookup table optimization process.

FIG. 2D illustrates, in flow chart form, a lookup table operation replacement process.

FIG. 2E illustrates, in flow chart form, a lookup table replacement process.

FIG. 3A illustrates, in flow chart form, a Modified Softmax operation computation process.

FIG. 3B illustrates, in flow chart form, an implementation of the Modified Softmax operation process

FIG. 4 illustrates, in flow chart form, a normalization operation that includes a set of N input values to be normalized.

FIG. 5A illustrates, in flow chart form, an exact elementwise computation process

FIG. 5B illustrates, in flow chart form, an exact dot product computation process.

FIG. 5C illustrates, in flow chart form, a exact computation reduction process.

FIG. 6 illustrates, in flow chart form, a process of data formatting for machine learning implementation.

FIG. 7 illustrates, in diagram form, a situation where the disclosed invention may be used.

FIG. 8A illustrates, in diagram form, aspects of a computer system that may use the disclosed invention.

FIG. 8B illustrates, in diagram form, another aspect of a computer system that may use the disclosed invention.

### DETAILED DESCRIPTION

The following description provides different embodiments for implementing aspects of the present invention. Specific examples of components and arrangements are described below to simplify the explanation. These are merely examples and are not intended to be limiting. By way of example, and without limitation, the description of a first component coupled to a second component includes embodiments in which the two components are directly connected, as well as embodiments in which an additional component is disposed between the first and second components. Furthermore, the particular features, structures, or characteristics may be combined in any suitable manner in one or more embodiments.

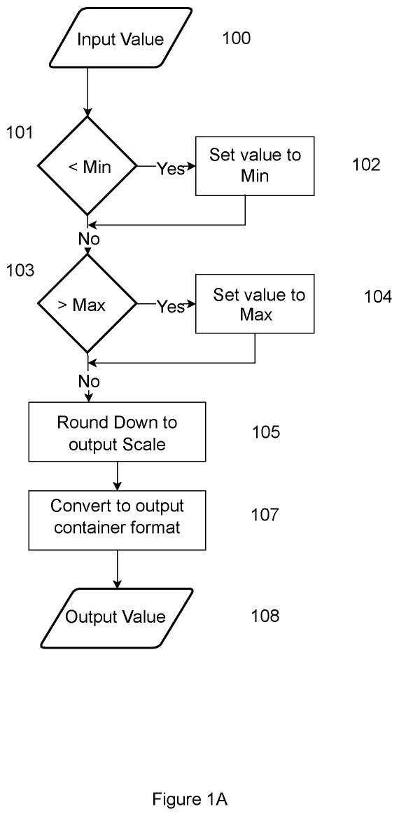

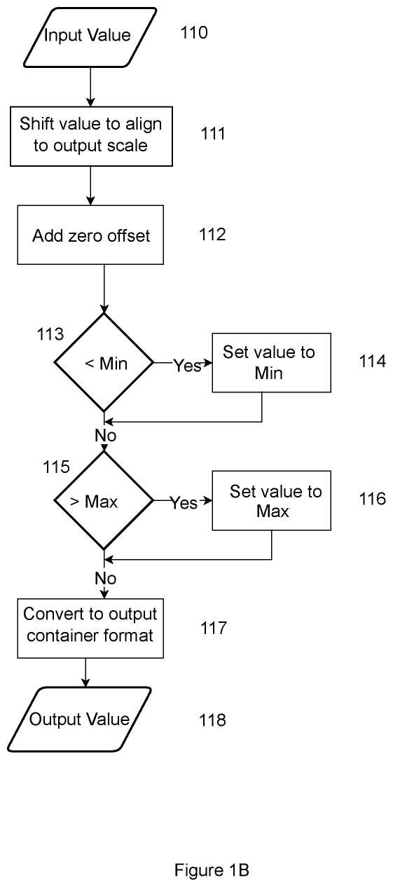

One of the important aspects of ensuring exact computation is an exact method to reduce the precision of a value. We will call this procedure “clip”, although in the art it may also be known with techniques such as “clamp” or “saturate” or “re-quantize”. FIG. 1A illustrates, in flow chart form, a process to reduce the precision of a value.

Given a floating point value 100, we first need to constrain the range of the floating point range to one that is allowed by the desired constrained range for the output. In 101 the value is compared with a computed minimum value, and if the value is below the minimum value it is replaced with the minimum value in 102. Steps 101 and 102 may combine in some implementations with the floating point “max” operation. In step 103 the value is compared with the computed maximum value, and if the value is above the maximum value, it is replaced with the maximum value in step 104. Steps 103 and 104 may combine in some implementations with the floating point “min” operation. In step 105 the value is rounded to the desired “scale” parameter (which may also be known as the “stepsize”). By way of example, and without limitation, if the “scale” parameter is 0.25, step 105 would round the value down to the lower multiple of 0.25. Since the value has already been constrained to the desired minimum and maximum value in steps 101-104, this rounding cannot overflow the desired output range.

Once the floating point value has the desired scale and value range, it can be converted to another container format in step 107 without any change in value, assuming that the minimum, maximum, and scale values are configured to constrain values that can exactly be contained in the desired container format. By way of example, and without limitation, if the input value and computation in steps 100-105 are done in “double precision” floating point values, if the scale is set to 0.25, minimum value is set to 0, and maximum value is set to 63.75, the value computed in steps 101-105 can be exactly contained in a half precision floating point value with no change in the computed value. Once the value is converted into the desired output container format it can be stored into the desired output value in step 108.

As shown in FIG. 1B, a similar technique is used for integer-style computation. Given an input value 110, the value needs to be aligned to the desired output scale in step 111. This is typically done with a shift operation. As an example, if the “scale” parameter is 1.0, and the input value has an effective “scale” parameter of 0.125, and the desired alignment is to have the value in the least significant bits, then the input value does not have the desired alignment. Shifting the value “right” towards the least significant bits by three positions will cause the value to have the correct alignment. As an example of a common implementation, if the input value is a two's complement value, the common computer operation “arithmetic shift right” has the desired behavior.

Once the value has the desired alignment, a “zero offset” value may be added, in step 112, to help encode a desirable value range into the output container format. By way of example, and without limitation, if the desired container format is an unsigned value between 0 and 255, but the value range of −128 to 127 is desired, a “zero offset” of 128 can be added in step 112 to convert the value range to what is desired for the output format. In some instances the zero offset value may be zero, and this step may be omitted, as addition with zero leaves a value unchanged.

After the zero offset is added, the value can be constrained to the value range allowed by the output container format. To accomplish this, the value is compared with the minimum value in step 113. If the value is below the minimum value, the value is replaced with the minimum value in step 114. Similarly, in step 115 the value is compared with the maximum value and replaced with the maximum value in step 116 if the value is above the maximum value. Steps 113 and 114 may be implemented with a “max” operation in some implementations, and steps 115 and 116 may be implemented with a “min” operation in some implementations. Furthermore, steps 113 to 116 may be implemented in some implementations by a “saturation” operation. As an example, if the output container format can hold a value between 0 and 255, the minimum and maximum values can be set to 0 and 255, respectively.

Once the value is constrained to the appropriate range, the value can be converted to the appropriate container format in step 117. By way of example, and without limitation, if the value is between 0 and 255, it could be exactly converted in step 117 to an unsigned byte. Once the value is converted to the appropriate container it can be stored as the output value in step 118.

Implementations may reorder these operations in various ways. By way of example, and without limitation, constraining the values to the minimum and maximum value in steps 113-116 could be done before adding the zero offset in step 112 by adjusting the minimum and maximum values by the zero offset.

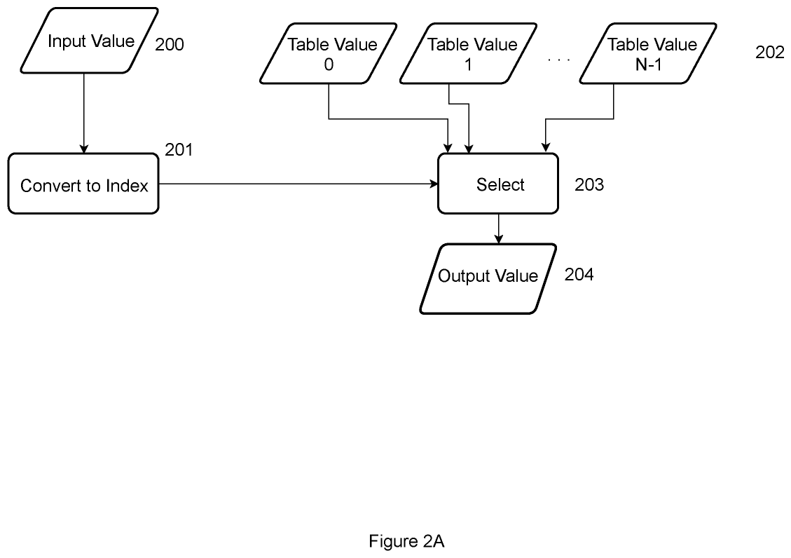

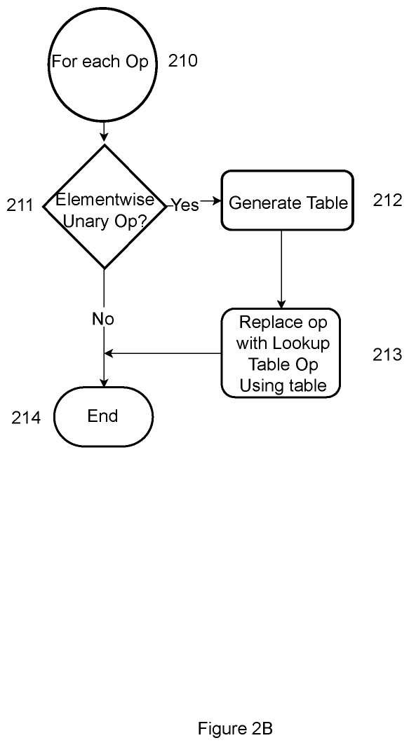

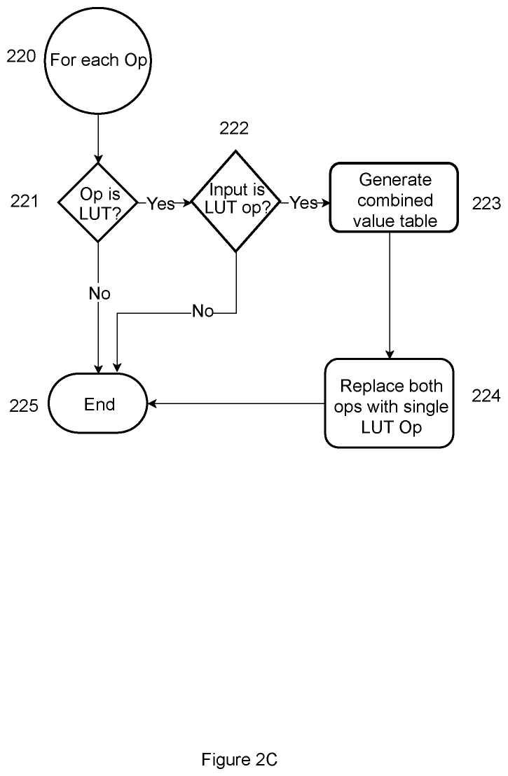

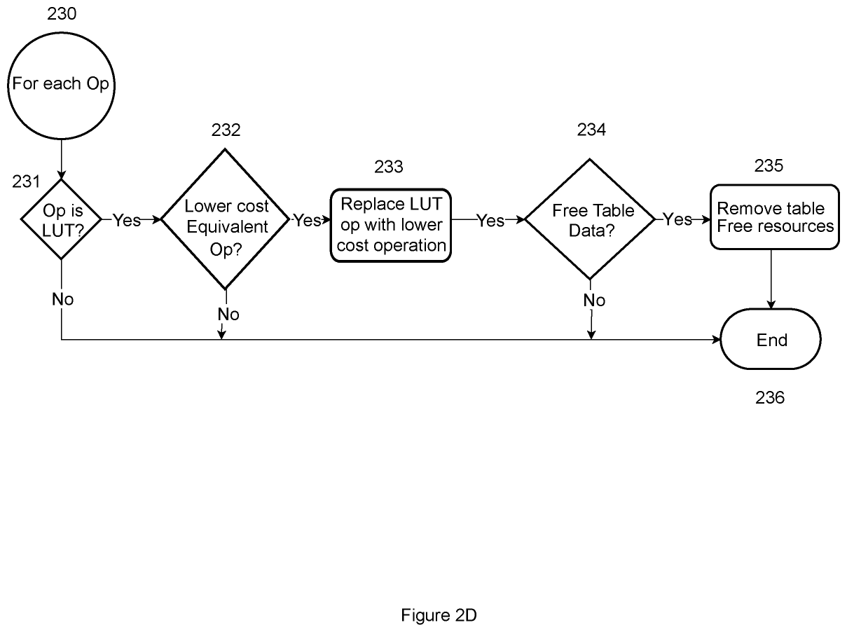

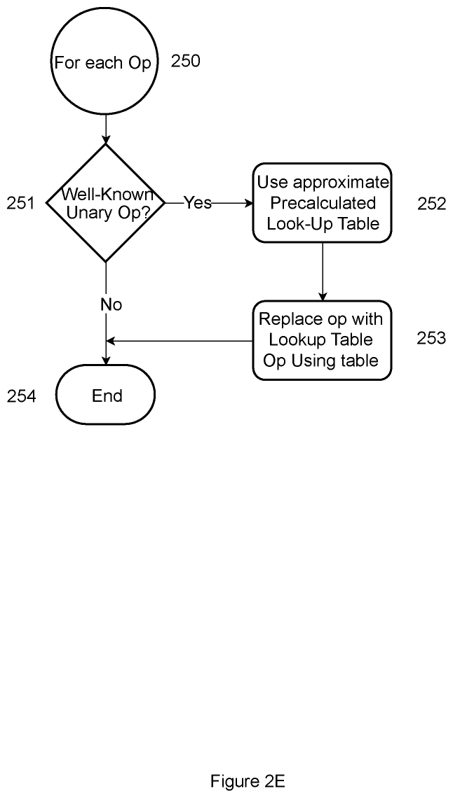

Many elementwise unary operations can be computed by a lookup table, sometimes known as a LUT. In FIG. 2A we show the lookup table operation and techniques for using lookup tables in efficient ways. The lookup table operation has as an input (200) a table of values (202), with N values identified as Value 0, Value 1, etc, through value N−1. As an example, a table with 256 values would have table value 0 through table value 255.

The lookup table operation selects one of these values in step 203 as the output value, which is stored in step 204.

Which table entry is selected is based on the additional input value 200, which may be converted to a table index in step 201. By way of example, and without limitation, if the input value 200 is a signed integer value with values between −128 and 127, step 201 might add 128 to the input value to convert the values to the index needed by selection operation 203. If the input value 200 is a floating point value, it may need further processing to convert it to the table index required by 203.

Steps 200-204 are often repeated for many independent values in a set of data, each corresponding to a different input value 200 and thus a different output value 204. It is common for these independent values to share the table values 202.

Given a set of operations on data, many of these operations may be unary operations that are the same for each element in a set of data. By way of example, and without limitation, a set of data (such as an array, matrix, or tensor) may go through an operation that takes the exponent, logarithm, square root, reciprocal, sine, cosine, tangent, Rectified Linear Unit, Swish function, Sigmoid, Hyperbolic Tangent, or other operation. Any operation that performs the same operation on each element of the data and has only the variable input values that determine the output values can be converted to a lookup table operation.

FIG. 2B illustrates a data optimization process. To optimize a set of operations on data, for each operation we start the optimization procedure at 210. If the operation is not an elementwise unary operation, as determined in step 211, it cannot be replaced with a table lookup operation as described in this procedure, so we will not modify it, and end the procedure at 214. However, if the operation is a unary elementwise operation, we can compute the result value for each possible input value and create the lookup table in step 212. Once this table has been created, we can replace the operation currently being considered with a lookup table operation in step 213. After replacement there is no further step for this procedure, so it ends at step 214. It should be noted that the derivative of an operation represented as a table lookup can be approximated by using adjacent table values.

It is surprisingly common that two unary operations appear in series. Once these have been converted to table lookup operations using the procedure in steps 210-214, we can apply an additional optimization, as shown in FIG. 2C. To perform this optimization, we again investigate each operation in a set of operations and start the procedure for each operation in step 220. Step 221 checks if the operation is a lookup table operation. If the operation is not a lookup table (LUT) operation, this procedure does not apply, and we end the procedure at step 225. If the operation is a lookup table, at step 222 we consider the operation that produces the input values (220) to the lookup table operation. If this second input value operation is not also a lookup table (LUT) operation, we cannot perform this procedure and end the procedure at step 225. If both operation checks 221 and 222 were true, we can replace the operation being considered as well as the operation that produces the input values with a single Lookup Table operation. In step 223 we use the table values from the two operations and produce a new table that produces the correct final output value for any possible input of the predecessor lookup table operation. In step 224 we replace both the identified operations with the single lookup table operation. There is no further work to perform in the procedure and so it ends at step 225.

Those skilled in the art will understand that repeated applications of steps 220-225 can optimize any number of dependent lookup table operations into a single lookup table operation.

Lookup table operations can be expensive, especially when the number of table entries is large. Implementations may have more efficient ways to implement the original operations than trying to perform the operation by table lookup. By way of example, and without limitation, the Rectified Linear Unit operation is the maximum of the input value and zero. The lookup table for this operation has a zero value in each position corresponding to a negative input value, and a value equal to the input value for each position corresponding to a non-negative input value. However, many operations can implement this operation more efficiently using a “max” operation than by table lookup.

The procedure for replacing a lookup table (LUT) operation with another operation starts with visiting each operation in a set of operations, as seen in FIG. 2D. For each operation, we start the procedure at step 230. In step 231 we check to see if the operation is a lookup table (LUT) operation. If it is not a LUT operation, we cannot optimize it with this procedure and so the procedure ends at step 236. If it is a LUT operation, we inspect the table values in step 232 and determine whether there is an equivalent operation that is lower cost than a lookup table operation. If not, we end at step 236. If there is an equivalent operation, we replace the LUT with the equivalent, lower-cost operation at step 233.

The tables may be large in LUT operations. Therefore, if the LUT operation is replaced with another operation, the original tables may no longer be needed, and it may be advantageous to release any resources used by the table entries. However, this may not be possible depending on whether the table entries are used in some other way or if the implementation cannot free resources. Step 234 checks if the resources used by the table should be released. If not, the procedure ends at step 236. Otherwise, in step 235 the table is removed and the resources used by the table entries are freed.

There are a variety of ways that step 232 can be implemented. Well-known operations may have lookup table values that can be recognized by inspecting the values or some value created based on the table values (such as a value computed by a hash function). As shown below, this is a common case. Some implementations may have techniques for approximating arbitrary functions, such as polynomial approximation, piecewise polynomial approximation, or interpolation between values in a smaller table. Any procedure that will exactly reproduce the table values may be substituted for the Lookup Table operation, however it will only be beneficial to do so if the new operation is better than the lookup table operation in some desired way. By way of example, and without limitation, the new operation may take less memory, less time, or less energy than the lookup table procedure. Different implementations may have very different facilities and goals for optimization and may make different choices in what and how to optimize the table lookup operations.

When unary ops are being replaced with lookup tables, many unary ops are well-known and used in machine learning graphs commonly, such as: tan h, sigmoid, square root, log, exponent, absolute value, clamping the range, swish, gelu, and many other functions. These well-known operations often do not need any specific exact implementation, and enabling an approximate variant of the function that is close to the desired function but easier to compute can be advantageous. As an example, in the art the “swish” function is sometimes replaced with a “HardSwish” function that is easier to compute.

As described above, some lookup tables can be implemented with simpler implementations. Replacing well-known unary operations with lookup tables that are approximate and known to have efficient implementations can help performance later on.

The procedure for this is shown in steps 250-254. Similar to steps 210-214, we will replace the unary computation with a lookup table. We inspect each op in the graph, starting the consideration at step 250. However instead of generating a table with the exact desired outputs, when we detect a “well-known” operation in step 251 that is known to behave well with approximate results and has a more efficient approximate implementation, we use a lookup table with the desired approximate values instead of the exact values in step 252. This table may be precomputed. In step 253 we replace the unary operation with the lookup table operation using the approximate table. Whether the operation is replaced or not, we complete the procedure for each operation in step 254.

Those skilled in the art will understand that these procedures can be used to convert many operations in a machine learning graph into an optimized set of Lookup Table (LUT) operations that specify exactly the desired output values. Furthermore, these exact output values can then be used as an exact specification for any implementation to create operations that produce exactly correct results utilizing whatever features are available in the implementation. This combination of exact portability and high efficiency is very desirable.

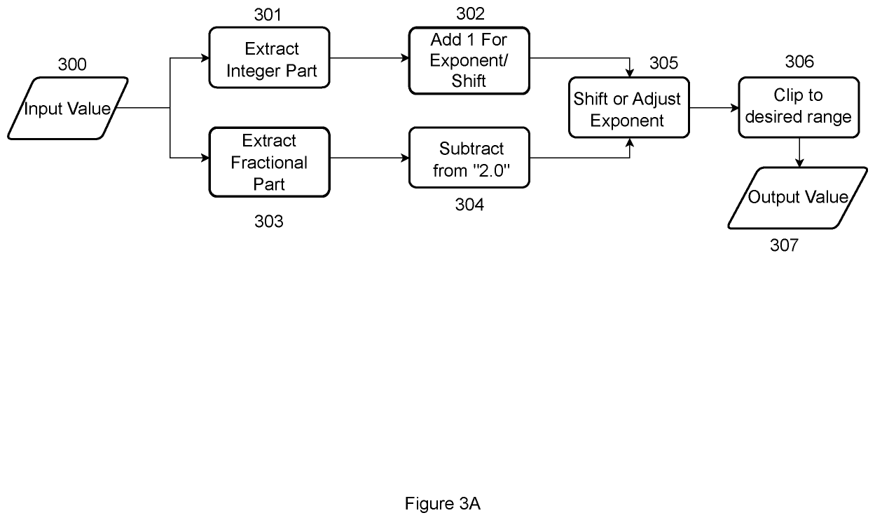

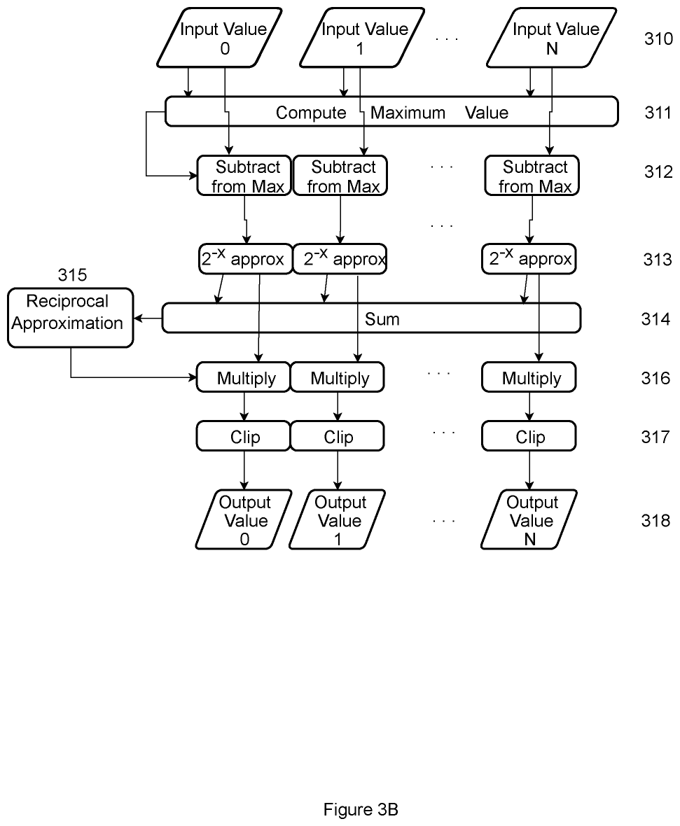

The Modified Softmax operation computation is illustrated in FIG. 3A. Steps 300-307 describe an approximation of the 2-x function that will be used in the overall Softmax procedure, in steps 310-318.

To create an estimate of 2-x, the input value is split into two parts. In step 301, the integer part is extracted. By way of example, and without limitation, if the value in step 300 is 2.34, the integer part would be “2”. In step 302 we add 1 to the integer part, yielding 3 in our example. This will be used in step 305 to shift or adjust the exponent. In step 303, we extract the fractional part. In our example value of 2.34, the fractional part would be equal to 0.34. We subtract this value from 2.0 in step 304, which in this example would yield a value of 1.66. In step 305 the value computed in step 304 is scaled down in magnitude according to the value in 302. The power-of-two exponent is adjusted in floating point computation (via an operation like the “Idexp” operation) or multiplied by 1.0 with the exponent adjusted by the computed value. For fixed point computation, the value is shifted right in fixed point computation. In our example, the adjustment of the exponent is equivalent to multiplying by 2-3, or 0.125. 1.66 times 0.125 is approximately 0.21. 2-2.34 is approximately 0.20. In step 306, the value is clipped to a desired range. In some fixed-point implementations, this may happen automatically by the right shift with carefully chosen fixed point locations. In floating point computation, it is important to reduce precision of small values and clamp very small values to zero. Once we have the exact value for the estimate, the output value is produced at step 307.

If it is desirable for a more accurate estimate, this procedure can be modified by replacing step 304 with a higher precision computation. This would need to be done carefully for reliable recreation in all implementations, however simple polynomial approximations exist that can increase precision.

After the exponential approximation is understood, we proceed to the overall Modified Softmax implementation, in FIG. 3B. Whereas a typical softmax is based on the exponential of the constant “e”, the modified softmax is based on the exponential of 2. In order to recreate the behavior of the typical softmax, the input values (310) can be multiplied by log 2(e). We assume that the input values (310) already have this applied if desired.

The input values at step 310 contain a set of values that the softmax operation is applied to. The softmax operation will normalize the input values such that their sum is approximately 1.0, and the largest input value has a larger input value than the other values. The larger the difference between the largest input value and the other values, the closer the corresponding output value will be to 1.0.

Because taking the exponential of large positive values can quickly produce values that overflow, a common technique for the stability of computation is to find the maximum input value and use it to normalize the values. In step 311 we find the maximum input value. In step 312, each input value is subtracted from the maximum input value. This yields positive values, with a guarantee that at least one value is 0.

We then find an exact approximation for 2-x for each of these computed values using the procedure shown in steps 300-307. The values returned by the approximation contain at least one value corresponding to 1.0, and no values greater than 1.0. Also, recall that in step 306 the value is clipped to a fixed range. The fixed range of values assists in finding the sum in step 314. The sum over all the exponential approximations is computed in step 314. An approximation of the reciprocal of this value is computed in step 315. This reciprocal approximation is multiplied by the exponential in step 316. The resulting values are clipped in step 317 and saved as the output values in step 318.

A large number of similar values in the input 310 may result in a large sum. If this happens, the result sum 314 may be saturated to a value that will yield a zero in the reciprocal computation 315, such that when multiplied in step 316 the results will all be zero. Said another way, because the reciprocal approximation in step 315 will produce a zero value output for many large values of the sum 314, it does not matter which of those large value is produced by the sum 314 and implementations may choose to use any large value which will produce the correct reciprocal in step 315.

As the number of elements becomes large, it may become difficult to manage a large number of exponential results 313. Implementations may wish to store the results to temporary storage, or to recompute the values after the reciprocal approximation is computed in step 315.

Another way to normalize data is to compute the mean and standard deviation, and for each input value to subtract the mean and divide by the standard deviation. This produces output values that are the amount above or below the mean in units of standard deviation: a value of zero indicates the value was the mean value, a value of 1.0 indicates a value one standard deviation above the mean value, and a value of −1.0 indicates a value one standard deviation below the mean value. This procedure can further be modified by adding a constant value, often known as the “Beta” parameter, to each output value to adjust the mean of the output. The procedure can also be modified by multiplying by a constant value, often known as the “Gamma” parameter, to each output value to adjust the amount of output range associated with a standard deviation. If the beta value is “1.0” and the gamma value is “0.5”, an output value of 1.0 indicates the mean value, 1.5 would indicate a value of one standard deviation above the mean value, and 0.5 would indicate a value of one standard deviation below the mean value.

### Bit Exact Exponent and Log:

Exponentiation and Logarithm operations are less commonly used than dot products in machine learning, but do happen in some important operations.

While the natural logarithm and power of “e” are typically used in machine learning, the first simplification is to change the computation to the logarithm and power of 2. e**x is equivalent mathematically to 2**(x*log 2(e)), so multiplying the inputs by a constant will make the computation match fairly closely. Similarly, the result of log 2 can be multiplied by 1/log 2(e)) to yield the result of the natural log.

Each integer increment of the input value for the 2**x function yields a doubling of the output value. The endpoints on the integer input values are exact integer output values (or for negative input values, exact reciprocals of integer values). In each of these ranges, the curve between the endpoints in each range is the same if the scale is ignored.

The curve is fairly well approximated with linear interpolation between the two endpoints. This yields the well-known approximation of (1+frac(x))*2**floor(x)). If we have separated integer and fractional parts, the value is (1+fractional)*2**integer. For fixed point values, 2**integer can be accomplished via a shift, and for floating point values 2**integer can be done by adjusting the exponent field or by using a math library function such as ldexp. This approximation greatly simplifies bit exactness, and relative error is less than 10%.

Exp2 has a well-known simple approximation of (1+frac(x))*2**(floor(x)). If we have separated integer and fractional parts, the value is (1+fractional)*2**integer. For fixed point values, 2**integer can be accomplished via a shift, and for floating point values 2**integer can be done by adjusting the exponent field or by using a math library function such as Idexp.

This approximation simplifies the bit exact portability. Error is under 10%. If improved accuracy is required, <1% error can be obtained from a quadratic function using simple constants: ((⅓)x\hat{ }2+(⅔)x+1). Another approximation is to calculate 1.5*log_2(x) with the approximation (1.5+x)*(1+0.5*x).

Similarly, approximate log can be done using a linear approximation of each power of two octave. In Floating point representations, this is easily calculated because the power of two is kept in the exponent field and the linear amount between the range [1.0,2.0) is kept in the mantissa field. With an integer or fixed point input, the value must first be normalized, but many architectures provide a “count leading zeros” or “count leading bits” instruction that can find the appropriate shift amount to normalize the value and that becomes a part of the integer part of the resulting log 2 approximation.

Using these approximations we can create log and exponent approximations that utilize simple integer arithmetic components (shifting, addition, count-leading-zeros).

If a closer approximation is desired, error can be reduced by replacing the linear interpolation with a polynomial function. One such function is ((⅓)x\hat{ }2+(⅔)x+1) for the fractional part x. Simple polynomial approximation can reduce the error to under 1%.

Logarithms have a symmetry with exponentiation and the same techniques apply in the symmetrical way.

For a fixed point result, care must be taken to avoid overflow, since exponentials of positive values can get large very quickly. Taking the exponent of negative values, however, is shifting right towards smaller values. This is safe. As the values get more negative, the farther the shift right, and eventually the bits will be shifted off (rounding down) or the value will be shifted out entirely resulting in zero. This is appropriate for the fixed point result.

Note that an operation only doing log or exponent can be replaced with a table lookup, although the operation is used as a component of the Softmax operation (further described below) and so is described separately here.

### Bit Exact Softmax:

One operation that utilizes exponentiation in machine learning is “Softmax.” The Softmax operator finds the smooth isolation of the maximum value or values. Using the exponential of all values makes large values much larger than small values. Finding the sum of these and dividing by the sum ensures that the sum equals 1.0, which has certain advantages such as making the result equivalent to a probability distribution function.

Softmax is not scale invariant: Softmax of larger magnitude values yields a different distribution than smaller magnitude values. Therefore, scaling the input values is not identical. However the behavior is similar. If we redefine softmax as exp2(xi)/sum(exp2(xi)), We can get the same answers by scaling all input values by log 2(e) (approximately 1.44), since exp(x)=exp2 (x*log 2(e)).

To avoid large value overflow, it is common for softmax implementations to find the maximum and subtract all values from the maximum. This means the exponential is of a value less than or equal to zero, which means the result of the exponential is less than or equal to 1.0.

Using the exp2 approximation above with these renormalized input values, we get a sequence of fixed point values. These fixed point values can be added together using integer arithmetic or by utilizing the “bit exact dot product” techniques above, since addition is dot product with a vector of 1.0 values. To ensure bit exactness, the amount of precision kept for the exp2 approximation needs to be well defined.

The sum is guaranteed to be a positive value greater than or equal to 1.0, since 2**0 is guaranteed to be in the set of data. Therefore, the reciprocal is guaranteed to be a positive value less than or equal to 1.0. We can use this knowledge to generate a bit exact fixed point reciprocal value approximation using similar techniques to the fixed point reciprocal square root calculated for normalization.

Once this reciprocal has been calculated, all the exponentiation results can be multiplied by the reciprocal. The implementation may choose to keep the exponentiation results or may choose to recalculate them.

To calculate the softmax, we first calculate the maximum value over all of the input and initialize the accumulator with zero.

Next, we take each input, subtract it from the maximum value, and multiply it by some factor. This factor might be a specified parameter of softmax to adjust its sensitivity to the input, or it might be log 2(e) to make it more numerically similar to typical softmax based on e\hat{ }x instead of 2\hat{ }x. After multiplying the input, the value is broken into the integer part and fractional part.

The fractional part is modified with a constant, such as adding “1” to it or subtracting the fraction from “2”. The fractional part is shifted by a value determined by the integer part. The resulting shifted value is truncated to a known precision. This value is then added to the accumulator. Repeat the process for all values.

Once the accumulator holds the sum of exponents of all values, we need to find a well-defined approximation of the reciprocal. Since the accumulator is known to be a positive number greater than 1.0, the reciprocal is known to be a positive value less than 1.0. The reciprocal estimate might be defined to be, By way of example, and without limitation, a 32-bit value representing the range [0.0,1.0) and the nearest value strictly less than the true reciprocal value (rounded down). Alternatively, the value could be defined to be rounded up or rounded by some other means. As long as the rounding is deterministic and well-defined an exact reciprocal estimate value can be determined for any accumulator value.

Once the reciprocal value has been determined, it is multiplied by all the exponential-approximation of each input value. These may be recomputed or the intermediate values may have been saved.

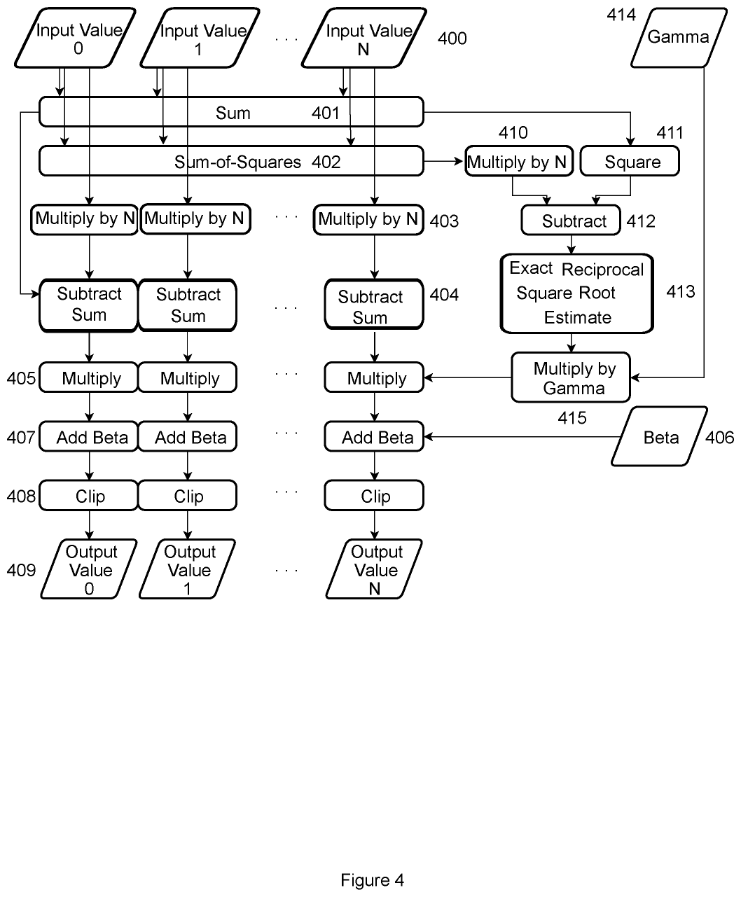

FIG. 4 shows a normalization operation that includes a set of N input values to be normalized (400), along with a Gamma input (414) and a Beta input (406). The exact sum of all input values is computed in step 401, and the exact sum-of-squares of all input values is computed in step 402. Note that the computations in steps 401 and 402 require extra precision to yield exact results. The result of step 402 is multiplied by N (the number of input values (400)) in step 410. The result of step 401 is squared in step 411. The result of 410 is subtracted from the result of step 411 in step 412. This difference is the standard deviation squared times the number of elements squared. Throughout this computation, exact computation is required.

In step 413 we take an estimate of the reciprocal square root of step 412. The result of step 412 may be zero, or may be a very large value. The reciprocal square root estimate must be able to handle a variety of input values. The result is the reciprocal of the product of the standard deviation and N. Once the reciprocal square root estimate is determined, it is multiplied by the Gamma term input (414) in step 415. This scaling factor will be used in step 405.

We will now consider step 403, which takes each input value (400) and multiplies it by N, the number of input values (400). In step 404, the sum of all values (as computed in step 401) is subtracted from each product from step 403. This result is each input value, minus the mean of all inputs, times N. In step 405 we multiply each result of step 404 with the scaling factor computed in step 415. The number-of-elements (N) term cancels out in this step. In step 407, the Beta parameter input (406) is added to each product. In step 408 these values are clipped to the desired output configuration.

Of special consideration is when the result of step 412 is exactly zero. This happens if and only if all the input values are equal, and so the variance is exactly zero. Some implementations add a small value to ensure stability, but in this embodiment step 413 needs only to be finite. Since the result of step 404 will be exactly zero in the case that the variance is exactly zero, any finite value for step 413 will have the expected zero result.

First, we ensure the input is a set of fixed point values with B bits. We take the sum and sum of squares of each input value. This is the equivalent computation of the dot product as defined above, where the sum is a dot product of the input data with a vector of “1.0” values and the sum-of-squares is the dot product of the input data with itself. If there are N elements, the sum will require B+ceil(log 2(N)) bits to accumulate, and the sum-of-squares will require 2B+ceil(log 2(N)) bits to accumulate. For modest precision inputs and larger accumulation values, this is feasible.

As we wish to avoid division, instead of computing the mean-of-squares and mean-squared, we will compute the variance times N\hat{ }2. This will allow us to avoid dividing by N to find the mean or mean-of-squares. Instead we will need to multiply the sum of squares by N, and square the sum. These two results both require 2*B+2*ceil(log 2(N)) bits. For log 2(N) of 24 and B of 8, this results in a requirement for 64 bit value, but this is feasible for modern computers. If more precision is required, extending the precision of unsigned integer addition is very straightforward by utilizing multiple values.

Once we have N*sum_of_squares and the sum**2, we can subtract them. While this may cause massive cancellation, we have the full exact values and so can produce an exact result. This value is the square of the standard deviation times N**2.

To find the standard deviation, we need to take the square root. Looking forward, we are going to be dividing the input values by the square root, so finding the reciprocal square root in a single step is advantageous to limit the sources of inexactness. Fortunately, finding the reciprocal square root is straightforward and efficient using the newton-raphson recurrence.

In order to provide an exact answer, we need an exact definition for the reciprocal square root approximation. One definition would be the largest fixed point value that, when squared and multiplied by the radicand, is not greater than 1.0. This is the equivalent of “rounding towards zero” from the infinitely precise reciprocal square root result. It also yields an exact answer for exact results and the reciprocal square root of 0 would be the maximum fixed point value.

As a note, the value we have computed is the approximation of 1 divided by N times the standard deviation. This value could be multiplied by N to find the approximation of the reciprocal standard deviation.

Looking ahead, we need to take each input value, subtract the mean, and divide by the standard deviation. Multiplying this calculation by N/N, we convert it to taking the input value times N, and subtracting the sum of all values. This sum has already been computed above.

We have the reciprocal “N times the standard deviation” calculated. Multiplying the input value minus mean by N yields N times the input value minus the sum of all values. This sum has already been calculated and this removes the need for division of the sum by N. The N factor is compensated by the N included in the reciprocal we have already calculated.

In summary, each output value is calculated by:

Out[i]=(N*in[i]−sum(in))*invsqrt(N*sum(in\hat{ }2)−(sum(in))\hat{ }2)*Gamma+Beta

The invsqrt operation needs an exact definition, and we need sufficient range to avoid inexact computation in the rest of the computation. Additionally, this formulation is scale invariant if all elements of the input have a common scale. This is highly beneficial for block floating point or other schemes where all input values have a common quantization scaling factor.

We propose the exact definition for invsqrt as the largest fixed point value that, when squared and multiplied by the input value, is not greater than 1.0. This is the equivalent of “rounding towards zero” from the infinitely precise reciprocal square root result. Also note that the reciprocal square root of zero is well-defined as the maximum fixed point value. Since the sum and sum-of-squares are exact, the reciprocal square root is only zero if all the input values are equal, and in this scenario, the N*in[i]-sum(in) term will be an exact zero, and so any finite value for the reciprocal square root should yield a zero (+Beta) result.

Multiplication by Gamma and the addition of Beta can be included with an exact definition, or could be broken out into elementwise multiplication and addition.

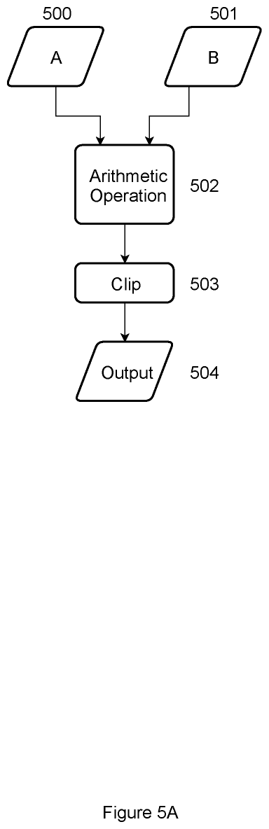

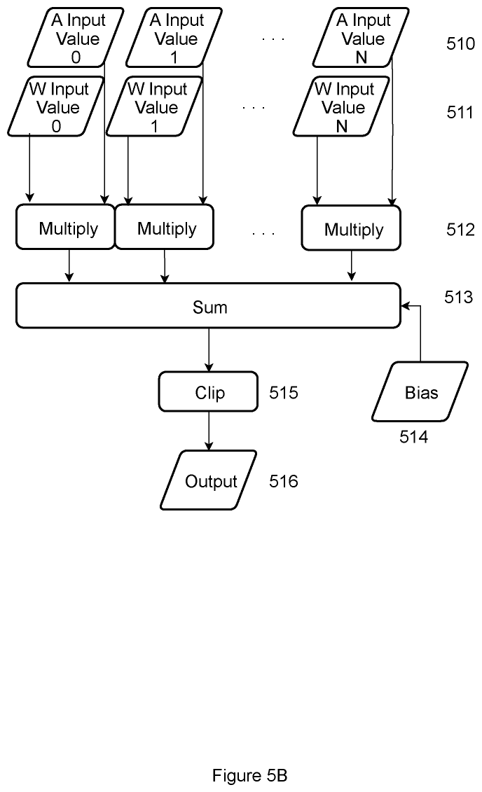

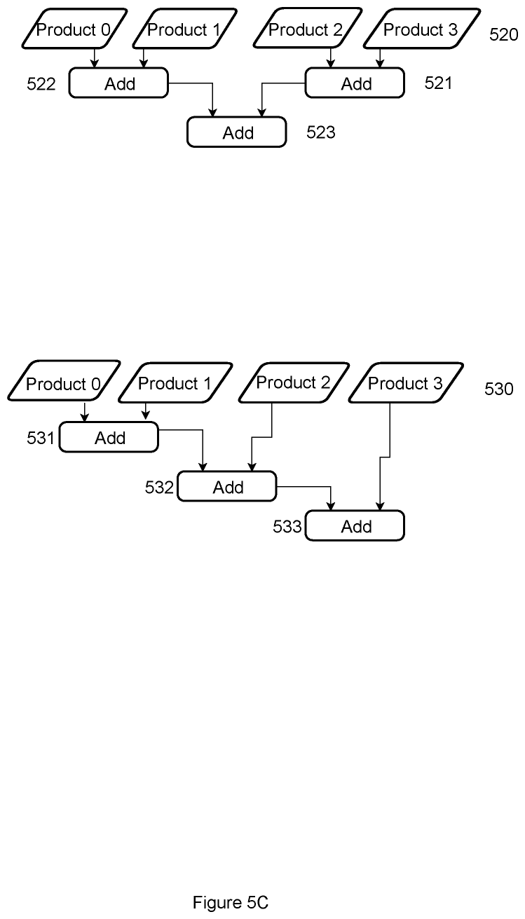

FIG. 5A-5B shows the elementwise computation (FIG. 5A) and the dot product computation (FIG. 5B). For exact elementwise computation, each corresponding element of two inputs, marked in the figure as the A input (500) and the B input (501), have an exact arithmetic operation performed on them (502). Some examples of arithmetic operations that can be exact are addition, subtraction, and multiplication. The full precision result is then clipped to the output type in step 503 and stored to the output in step 504.

For exact dot product, we assume we have two vectors, noted as A (510) and W (511). Each element in A is multiplied by the corresponding element in W (512). Then the result of all the multiplies are summed together to form the sum of all products (513). Additionally, a Bias term (514) can be added to the sum. During this computation, there must be sufficient precision for the sum to be exact for any combination of inputs that might have an exact output. The resulting sum is clipped in step 515 and stored into the output in step 516.

Those skilled in the art will note that exact computation can be reordered and that this allows for a variety of implementations of steps 513. Some examples of partial reductions are also shown in FIG. 5C. Given four partial products in 520, they can be summed in two stages by adding the first two products and the second two products in parallel (521 and 522), and then adding those sums together (523). Instead, the products can be added in a more sequential manner, such as the four elements 530 being added in steps 531, 532, and 533.

Further reorganization of the data is possible; By way of example, and without limitation, each multiplication in step 512 produces a variety of partial products internally, and these can be added in any convenient order with other partial products of 512 to form the sum 513. Having the exact computation allows for a variety of design options for performing the dot product in various ways.

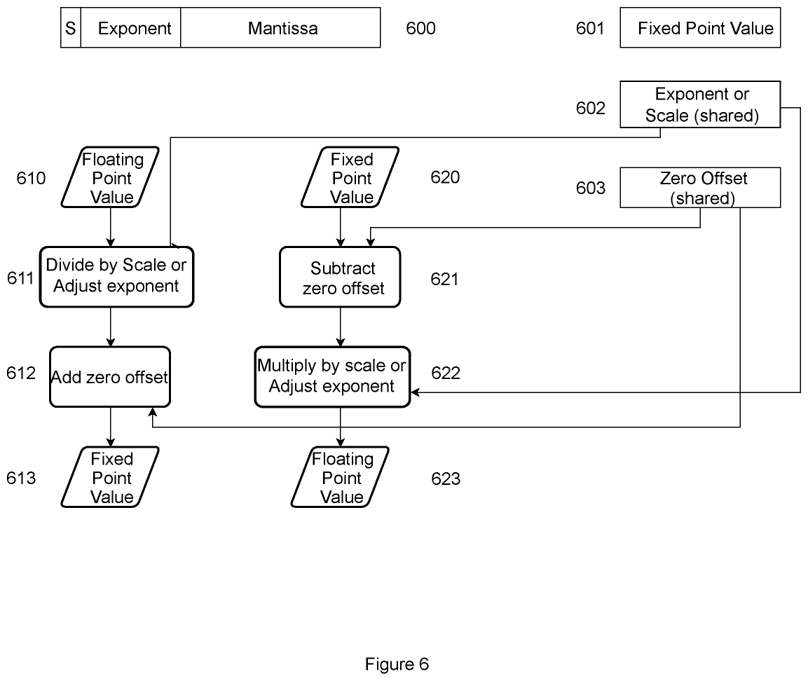

FIG. 6 shows two common data formats for machine learning implementations. The classic IEEE 754 Floating Point format is shown in 600, which contains a field for indicating the sign (negative or positive) of the value, the mantissa or significand, which is the fractional part of the value normalized to the range [1.0,2.0), and the exponent, which corresponds to two raised to the exponent power and is multiplied by the mantissa after adding the implicit one. The IEEE floating point format has been standardized and used extensively in the computer industry for over 40 years.

In order to simplify the arithmetic and provide for a more compact representation, another format for storing numerical values is to have a set of fixed point values and a shared exponent. This is known as “block floating point”, and its use predates IEEE floating point. In this representation, a set of values (601) have the integer and fractional part separated at a well known position. By way of example, and without limitation, the value could be entirely integer, or represent a value in the range [0.0, 1.0) which would be entirely fractional. Each of these values in the data set would also be multiplied by two to the power of the shared exponent (602) to interpret the “true” value. This exponent value can be kept as either the integer exponent, or the value of two to the power of the exponent. In the latter case this is known as the “scale” or “step size” of the set of values, since it indicates how much each incremental value of 601 actually corresponds to.

In some cases in machine learning groups of data, both positive and negative values need to be represented. In other cases, only non-negative values occur. In some systems this is optimized by having two types of values: signed and unsigned. There are cases where having a single type would be beneficial, and there are cases where the positive and negative ranges of the data may not be symmetric. Therefore, in some machine learning implementations a shared zero offset (603) is used to indicate what value in the range of quantized values indicates the zero point. This affects the arithmetic but more efficiently encodes various ranges of data into compact quantized values (601) in a single type.

Using the representation in 601-603, it is common for machine learning implementations to have good performance with the quantized values (601) having 8 bits. In order to achieve the same performance, a floating point format (600) would typically need a 16 bit data type. For the large sets of data often used in machine learning, this difference is extremely important for efficiency.

In order to convert from a floating point value (600) that is known to be exactly representable as a quantized value to a quantized value (601), the set of steps 610-613 may be used. Taking the floating point value 610, the value is divided by the scale in step 611, or equivalently the exponent is adjusted by the shared exponent of all the data. This step converts the floating point value to the correct number of steps. The zero offset is added to the data in step 612. If the zero offset is known to be zero, this step may be omitted. In step 613 the resulting value is stored as the fixed point value.

If the value is not known to be exactly representable as a quantized value, then the steps for the clip operation (FIG. 1A-1B) should be used.

In order to convert a fixed point value (620) into a floating point value, the zero offset is subtracted from the value in step 621, producing a signed value, and then the value has the exponent adjusted or is multiplied by the scale factor in step 622. Then the floating point value is stored into the result in 623.

Ensuring that the floating point values can be exactly representable as fixed point values means that steps 610-613 or steps 620-623 can be done without changing the value, and so implementations may convert the value to whatever kind of format is convenient for the implementation. To facilitate this, the scale factor 602 should be constrained to be an exact power of two, and the zero offset (603) should be an exact value in the range of the fixed point values. Additionally, values stored as floating point values should have their values constrained to the range supported by the quantized values, and must have sufficient precision to accurately represent all the fixed point values.

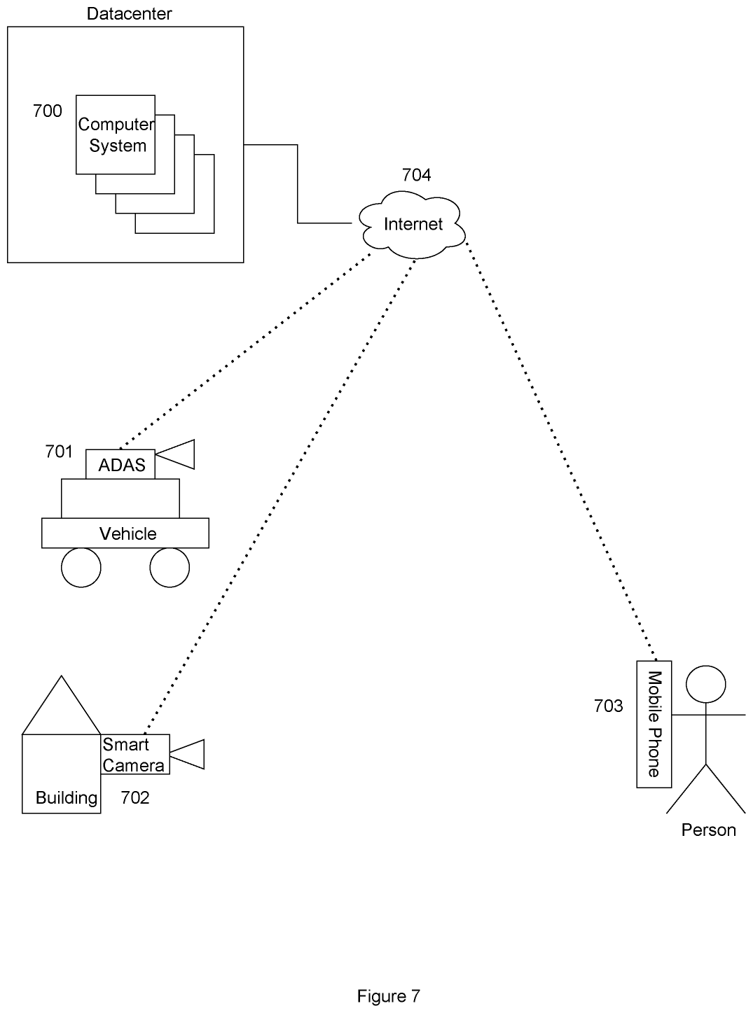

FIG. 7 shows situations where the disclosed invention may be used. Item 700 shows a Datacenter, which may comprise one or more computer systems in a facility designed to house computer systems in an efficient manner. Item 701 shows a vehicle with an Autonomous Driver Assistance System (ADAS) which includes a camera and computer system. Item 702 shows a smart camera, possibly attached to a building, which also includes a camera and computer system. Item 703 shows a mobile phone, which includes a computer system and other components. All these items may be able to communicate via the internet (704) through a wired or wireless connection. As is well known in the art, many objects have computer systems incorporated into them and these examples serve to illustrate several of the places where computer systems may be found. They may be found with or without additional sensory hardware such as cameras, microphones, or other sensory items.

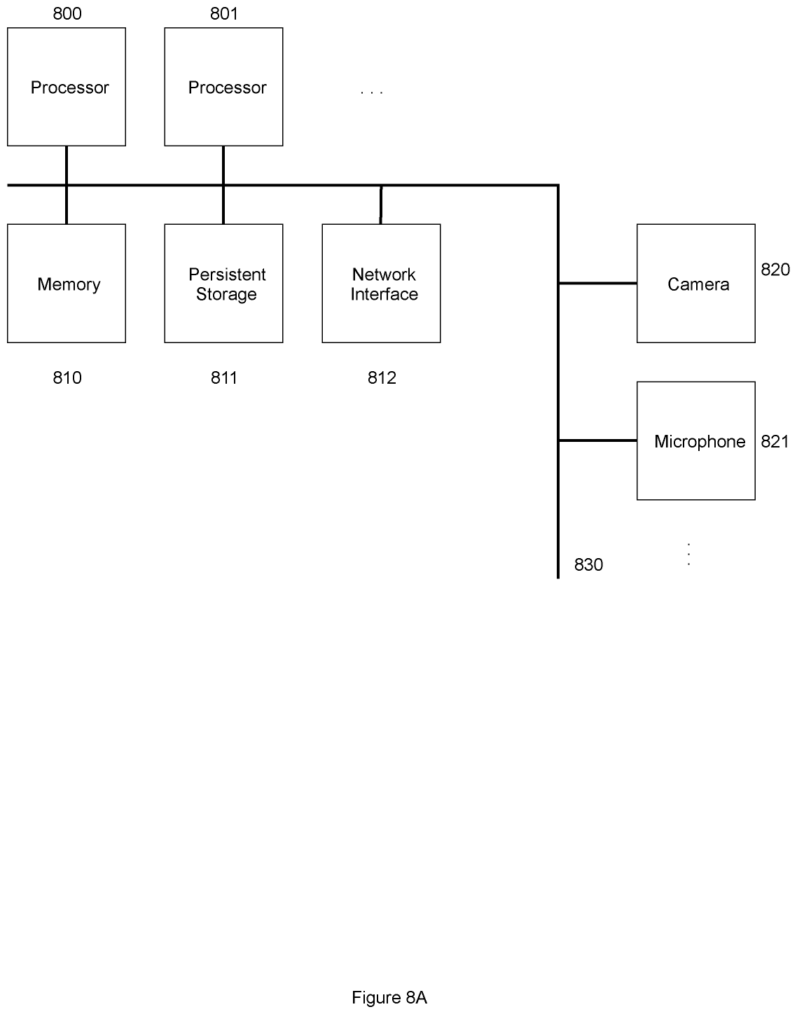

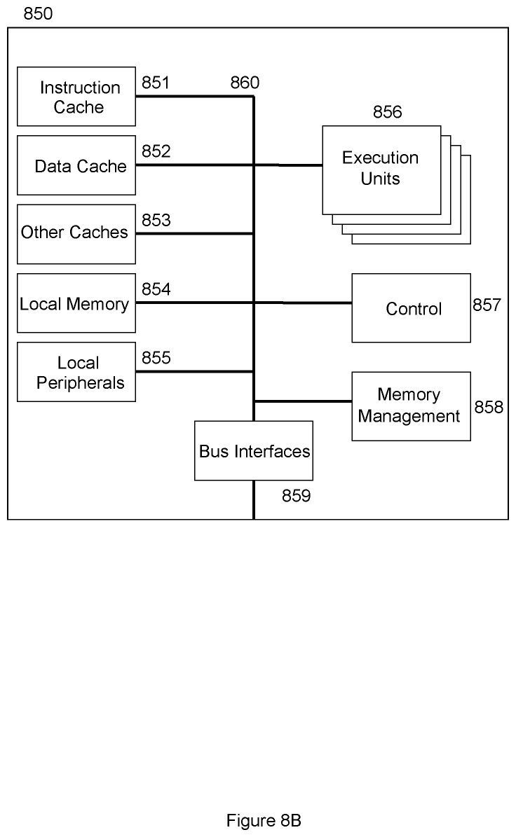

FIG. 8A-8B shows some aspects of a computer system. A computer system incorporates at least one processor (800), able to execute instructions and operate on data. Processor 800 may be processors such as a Central Processing Unit (“CPU”), a Digital Signal Processor (“DSP”), or other similarly defined processing units as would be understood by one of ordinary skill in the art of computing systems. It is very common for computer systems to incorporate additional processors (801 and more not shown) that may be identical to a first processor, or may be specialized for various purposes. These purposes might be to facilitate special kinds of computation (such as graphics, signal processing, or machine learning workloads), or to operate at higher performance or with more energy efficiency.

The processors may communicate with memory storage (810) such as DRAM and persistent storage (811) such as flash memory or a hard disk drive. These devices store values for later retrieval.

Computer systems may have network interfaces (812) that may allow them to communicate with other computer systems. Computer systems may also have interfaces to sensors or other interfaces with the environment. Some examples include cameras (820) and microphones (821).

The processors, memory, storage, network interfaces, sensor interfaces, and other peripherals may communicate with each other using a variety of communication interfaces, shown simply as item 830. These communication interfaces may comprise busses, switches, bridges, or other communication mechanisms. Additionally, items 800-830 may be implemented in a single system-on-chip (“SOC”) device, or may be split between many individual devices. As an example, a processor 801 might be a Graphics Processing Unit (“GPU”) card in a computer system, connected using the Peripheral Communication Interface (“PCI”) protocol. As a further example, a camera (820) might be attached via a Universal Serial Bus (“USB”) cable to a computer system.

A processor such as 800 or 801 may have several subcomponents as illustrated in 850. Internal to a processor, there may be a variety of local storage locations that can hold unique values or copies of values that may also exist in memory (810) or persistent storage (811). Many processors contain caches (851, 852, and 853) which may hold temporary values. They may be specialized for instructions (851), or data (852), or may be specialized for other kinds values or specialized to hold a large amount of data more efficiently (853) such as a level 2 cache. Processors may also contain local memories (854) that are able to be accessed efficiently by the processor 850. The use of memory may be managed by a Memory Management Unit (858) that may translate addresses to other addresses for ease of programming and to enhance the security of the computer system. Other peripherals used primarily by the processor may exist (855) such as timers, interrupt controllers, clock management, power management, debugging hardware, performance monitors, or other peripherals.

Values are operated on by one or more execution units (856). Some of these execution units may be optimized for special kinds of computation, such as floating point arithmetic, loading or storing values from memory, performing the same operation on many values in parallel (vector processing), or specialized for other kinds of computation such as graphics or machine learning computations.

Control logic (857) may also exist to orchestrate how the various components of the processor communicate with each other, what operations they perform, and when to perform them. Communication to other components of the computer system may be assisted with one or more bus interface components to communicate with the various communication mechanisms in the computer system (830). These hardware blocks may have a variety of mechanisms for communicating with each other, shown simply as 860.

Whether a computer system is in a datacenter (700) or in a mobile phone (703), even though the power consumption of the computer systems may be very different, the conceptual organization of the computer system in FIG. 8 is highly similar. Additionally, the kinds of computation performed in these different computer systems may be similar or even identical. As a concrete example, a machine learning workload may be trained and verified in a datacenter (700) using a large number of computer systems working together, and then deployed to mobile phones (703), possibly delivered using the internet (704). The mobile phone may then use this machine learning workload as a component of taking a picture using a connected camera (820).

While it is highly desirable for the computation to produce identical results in the various embodiments (FIG. 7), the computer systems performing the computation may be very different in different situations. Currently, many of the computations performed in machine learning workloads are not able to have exact results on different kinds of computer systems.

### Activation Functions

In machine learning workloads, there are a lot of unary functions that shape the values in some way. Some examples:

$$“ Relu ” : x = max ( 0 , x )$$

$$“ Log ” : x = log ( x )$$

$$“ Tanh ” : x = tanh ( x )$$

$$“ Sigmoid ” : x = 0.5 + 0.5 * tanh ( 0.5 * x ) ( or something like that )$$

$$“ PRelu ” : if ( x < 0 ) : x = a * x$$

$$“ Gelu ” : 0.5 * x * ( 1 + erf ( x / sqrt ( 2 ) ) )$$

$$“ Swish ” : x * sigmoid ( x )$$

And many, many more. Most activation functions are unary functions.

We define that all of them be replaced with lookup tables, defining the exact output for each possible input value. This ensures that all activation functions (indeed, all unary functions) can be supported with all combinations of input and output quantization in a portable way: the exact outputs for any given input are defined as the constant input for the lookup table in the graph.

At high precisions these tables could get large. Lookup tables, especially large ones, may be inefficient to use as a mechanism for computation. Implementations are free to go back the other way and find some simplified computation that gets the exact answer for all inputs. Depending on the features of the implementation software/hardware architecture that might yield lots of different options for implementation. As long as it gets the right output for any input, the replacement is valid. Note that as activation functions get fused in, rounding may make the exact results cumbersome, but the exact lookup table results must be respected for exact answers.

### Converting Unary Operations to Look-Up Table (“LUT”) Operations

Elementwise unary operations—those with a single input and single output, where the operation is the same for all elements—can be converted into a Look-Up Table operation in a straightforward fashion. For each possible input, the value of the desired output is computed and stored in a table. Then the table is indexed by the input value and the resulting output is returned. For common input precisions, such as 8 or 16 bit values, the table size is feasible for modern computers.

### Fusion of Lookup Table Followed by Another Lookup Table

A sequence of two lookup table operations is replaceable with a single LUT operation. For each input of the first LUT operation, the intermediate value is calculated, and then this intermediate value is used to index into the second LUT operation. The resulting value can be the table entry corresponding to the input value for the first LUT, and both operations can be replaced with a single lookup operation into a single table where the values contain the computation of traversing both lookup tables.

### Converting Look-Up Table (LUT) Operations to Other Operations

A lookup table is a straightforward way to define exact results for arbitrary unary operations. However, actually performing the lookup table computation may not be efficient, especially for large tables with high precision values. Any operation that produces the exact results of the lookup table can be used to replace the LUT operation if it is more efficient. This allows implementations to utilize whatever resources they have for execution of unary ops while still conforming to the desired bit-exact behavior.

### Visualizing the Lookup Table Operation

For every valid input point, there is exactly one valid output point. However if extra precision is used, many possible intermediate values with extra precision might form the correct output point at each possible input point. If the input and output points are already integer values and the output only encodes single digit values, then large sets of higher-precision intermediate values will map to the correct output value. This allows simple but approximate functions to stay within the error boundary of correct and valid outputs.

### Polynomial Approximation

Polynomial approximation techniques are well known for ways to estimate a function with another function. Polynomial approximation techniques can be used either to estimate a continuous function or to estimate a fit to a set of discrete points. In some cases, it may be possible to find a polynomial function that, when evaluated at any valid input point yields an output value that is in the range of values that will be rounded to the correct output value.

When finding the polynomial coefficients, the desire is to eliminate the places where the polynomial rounds incorrectly at an evaluation point. This is a slightly different requirement than common polynomial approximation techniques that might (for example) minimize the mean squared error at all points, and using the correct metric may help in finding optimal coefficients. However, even using common techniques for polynomial approximation can yield valid solutions.

### Piecewise Polynomial Approximation

In some cases the polynomial approximation may be too difficult to achieve. By way of example, and without limitation, it may require too many terms of too high a precision for the replacement function to be effective. Therefore, a common strategy is to find different polynomial approximations for different regions of the function. Each “piece” of the function can have different polynomial approximations and the complexity of the polynomial can often be reduced.

It is common for the coefficients to be loaded using a lookup table where the index indicates the piece of the function that is desired and the values in the table are the polynomial coefficients.

It may seem ineffective to replace a lookup table operation with another operation that uses a lookup table, however using piecewise polynomial approximations, the table size can often be dramatically reduced and this may yield a more efficient solution.

Fusing Look-Up Table Operations into Other Operations

In some cases, the LUT operation happens after another computation operation, such as a sum, product, or sum-of-products (“dot product”). In this case, there is often an intermediate value in the first operation that is of higher precision that is rounded to a smaller precision before the LUT operation.

This can be thought of as two LUT operations: one to convert the higher-precision intermediate value in the preceding computation to the smaller precision value, and the second LUT operation that follows. In some cases it may be possible to use the techniques above to fuse the LUT operation into the preceding operation, by doing additional computation on the intermediate result in such a way that after the additional computation, the output is equal to what would have happened if the operations had been performed separately.

### Tricky Situations

One of the situations that may occur—but that still must be respected—is when an intermediate lookup table has low precision compared to the overall desired range for computation. When this happens, the resulting table may have large ranges where many input values have the same output value, followed by a large jump to the next output value, skipping over many possible output values. This large jump may be hard to estimate with a simple polynomial, since the function is less continuous. There are a few techniques that may help the situation.

To visualize this, we again return to the “nearest integer” function but instead have input and output values quantized to steps of 0.1. This means that the range of valid intermediate values that correspond to the correct output values is reduced, since they must round to the nearest step which is now 0.1 instead of 1.0. Additionally, the input values are no longer on integer boundaries and are close to places where the function transitions from one output value to the next. The output values are separated by large “jumps” of ten steps. This makes approximate functions that stay within the designated area much more difficult to create.

One technique is to align the discontinuities on range edges. As an example, the step function, such as “1.0 if (x>=0); 0.0 otherwise” is easy to reproduce if the 1.0 results align to one set of values and the 0.0 results align on another set of values. This is not always possible.

Another technique is to compress the possible output values into a contiguous range. If the output scale factor in the previous example was very small, the step function is difficult to approximate because of the large change in value compared to the range that rounds to the output value. However if the output scale is 1.0, then the output values are adjacent and the step function approximation becomes much easier because there are no intermediate values that can be rounded to. The transition between values that round to zero and values that around to one needs to be at x=0 but the difference required is small compared with the range of values that round to either 0.0 or 1.0 in the output. Of course if this doesn't match the desired output quantization, a second lookup table or other computation would need to convert the value to the correct output range.

Tables with small number of discontinuities—such as the step function described above—can be implemented with identification of the special case. In the situation above, a detection of the x>=0 and the addition of the offset can entirely handle the discontinuity, since the operation is constant except for the discontinuity. Some examples of operators that may be utilized to handle discontinuity include absolute value, maximum, minimum, and comparison. Comparison can be especially helpful if the result of the comparison has a numeric value such as 0 or 1.0. However multiple discontinuities in a range may make the detection of them cumbersome.

Other arithmetic operations such as logical operations might be useful to mask less significant bits of output to handle the discontinuities. Masking off least significant bits effectively changes the quantization scale factor for the value. An example where masking off least significant bits might be beneficial is a lookup table that rounds values to a lower precision, followed by a lookup table that restores the original precision, similar to the “nearest digit” example. In some cases this might be able to be implemented by addition of a rounding factor and masking of the least significant bits (or other rounding technique).

Of course, many of these techniques can be different for different ranges of the computation by looking them up from a table. By way of example, and without limitation, the threshold and adjustment factor might be looked up for each range from a table. If an adjustment is not needed for a range, the adjustment factor could be set to zero or the threshold could be beyond the valid range. Similarly, if a mask to eliminate less-significant bits was desired, what mask should be used could vary in different ranges by having the value read from a lookup table.

### Frugal Tables

Frugal Tables are lookup table implementations for common functions that produce approximate solutions to common functions with compact tables and efficient arithmetic.

Optimized tables for a variety of functions provided:
ReLU
Leaky ReLU
Sigmoid
Tan h
Swish
Gelu
Elu
Softplus
Abs
Log/Log 2
Exp/Exp2
Reciprocal
Square Root

Although illustrative embodiments of the invention have been described in detail with reference to the accompanying drawings, it is to be understood that the invention is not limited to those precise embodiments, and that various changes and modifications can be affected therein by one skilled in the art without departing from the scope of the invention as defined by the appended claims. Thus, it will be apparent to one of ordinary skill that this disclosure provides for improved method and apparatus for use in machine learning operations.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above-described embodiment, method, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Terminology used in the present disclosure is intended to include all environments and alternate technologies that provide the same functionality described herein.

1. A computer system comprising:
a first processing system and a second processing system, said second processing system being further characterized as non-identical to said first processing system;
a machine learning computation that can be performed on a selected one of said first processing system and said second processing system;
said first processing systems, said second processing system, and said machine learning computation being adapted to produce identical results,
selecting a selected one of said first processing system and said second processing system to perform said machine learning computation as a function of a first criteria; and
performing said machine learning computation on said selected processing system.

2. The computer system of claim 1 wherein said first criteria is further characterized to comprise processor availability, load, and free capacity.

3. The computer system of claim 1 wherein said first criteria is further characterized to comprise thermal status.

4. The computer system of claim 1 wherein said first criteria is further characterized to comprise power budget.

5. The computer system of claim 1 wherein said first criteria is further characterized to comprise performance and latency requirements.

6. The computer system of claim 1 wherein said computer system is adapted to terminate said machine learning computation being performed on said selected processing system and resume said machine learning computation on a non-selected processing system.

7. The computer system of claim 1 wherein said first processing system comprises a Central Processing Unit (CPU).

8. The computer system of claim 1 wherein said first processing system comprises a Graphics Processing Unit (GPU).

9. The computer system of claim 1 wherein said first processing system comprises a DSP.

10. The computer system of claim 1 wherein said first processing system comprises a specialized hardware adapted to execute a machine learning workload.

11. The computer system of claim 1 wherein said first processing system is more energy efficient than said second processing system.

12. The computer system of claim 1 wherein said first processing system is higher performance than said second processing system.

13. The computer system of claim 1 being further characterized as comprising separate CPU and GPU devices.

14. The computer system of claim 1 being further characterized as comprising an SOC with differing hardware blocks.

15. The computer system of claim 1 being further characterized as comprising a datacenter comprising multiple differing computer types.
